(19) United States
(12) Patent Application Publication
(10) Pub. No.: US 2018/0223773 A1
(43) Pub. Date: Aug. 9, 2018

(54) POWER GENERATING ASSEMBLY, VEHICLE COMPRISING A POWER GENERATING ASSEMBLY, AND METHOD FOR ADJUSTING AN INERT GAS PRESSURE

(71) Applicant: MTU FRIEDRICHSHAFEN GMBH, Friedrichshafen (DE)

(72) Inventors: Manuel BOOG, Aulendorf (DE); Wolfgang FIMML, Hörbranz (AT); Jan Gerrit PRUNNBAUER, Lindau (AT)

(73) Assignee: MTU FRIEDRICHSHAFEN GMBH, Friedrichshafen (DE)

(21) Appl. No.: 15/748,854

(22) PCT Filed: Jul. 7, 2016
(86) PCT No.: PCT/EP2016/001167

§ 371 Date: Jan. 30, 2018

(30) Foreign Application Priority Data
Jul. 30, 2015 (DE) 10 2015 214 563.8

(51) Int. Cl. F02M 21/02; F02D 19/02; F02D 41/00

(52) U.S. Cl. CPC F02M 21/0221; F02M 21/0242; F02D 19/027; F02D 19/022; F02D 41/0027; F02M 21/0233; F02M 21/0293

(57) ABSTRACT

A power generating assembly including an internal combustion engine and a combustion gas supply connected to the internal combustion engine in order to supply combustion gas. The combustion gas supply has an at least double-walled line at least in the region of the internal combustion engine, the line having an inner line volume for combustion gas and an outer line volume. The outer line volume is fluidically connected to an inert gas supply. The power generating assembly also includes a combustion gas pressure adjusting device that adjusts a combustion gas pressure in the inner line volume, and an inert gas pressure adjusting device that adjusts an inert gas pressure in the outer line volume. The combustion gas pressure adjusting device and the inert gas pressure adjusting device select the inert gas pressure and the combustion gas pressure such that the inert gas pressure is higher than the combustion gas pressure.

The invention relates to a power generating assembly, to a vehicle having a power generating assembly and to a method for adjusting an inert gas pressure.

Classification conditions for marine applications of internal combustion engines which are to be operated with combustion gas typically provide measures for gas safety which, in particular, are intended to prevent an explosive mixture of combustion gas and air being formed in a machine room of a ship. For this purpose it is known to use double-walled combustion gas lines, wherein combustion gas flows in an inner line volume, and wherein an outer line volume is scavenged with air or an inert gas. Such double-walled lines are in need of improvement with respect to their leak tightness.

The invention is based on the object of providing a power generating assembly, a vehicle having such a power assembly and a method for adjusting an inert gas pressure, wherein the specified disadvantages do not occur.

The object is achieved by providing the subject matters of the independent claims. Advantageous refinements can be found in the dependent claims.

The object is achieved, in particular, in that a power generating assembly is provided which has an internal combustion engine and a combustion gas supply which is connected to the internal combustion engine in order to supply combustion gas. The combustion gas supply has, at least in the region of the internal combustion engine, an at least double-walled line which has an inner line volume for combustion gas and an outer line volume, wherein the outer line volume is fluidically connected to an inert gas supply. A combustion gas pressure adjusting device is provided which is configured to adjust a combustion gas pressure in the inner line volume. Furthermore, an inert gas pressure adjusting device is provided which is configured to adjust an inert gas pressure in the outer line volume. Adjusting the inert gas pressure in the line volume significantly increases the leak tightness of the at least double-walled line, since defined pressure conditions can be provided here. There is advantageously provision that the combustion gas pressure adjusting device and the inert gas pressure adjusting device are configured to select the inert gas pressure and the combustion gas pressure in such a way that the inert gas pressure in the outer line volume is higher than the combustion gas pressure in the inner line volume. In particular in this way the gas tightness and the leak tightness of the combustion gas supply are significantly increased in the region of the at least double-walled line, in particular since a leak in an inner wall which disconnects the line volumes from one another does not cause combustion gas to flow out into the outer line volume, but instead causes inert gas to flow into the inner line volume. Therefore, in such a fault situation it is not possible for an ignitable or explosive mixture to be produced, instead in the case of a relatively large leakage the internal combustion engine is choked off by the inert gas, with the result that a safe operating state is achieved.

The fact that the combustion gas supply has an at least double-walled line at least in the region of the internal combustion engine means, in particular, that the double-walled nature of the line is provided in the direct surroundings of the internal combustion engine, in particular in a closed-off space in which the internal combustion engine is arranged. The internal combustion engine is preferably arranged in a machine room in which the combustion gas supply has an at least double-walled line. The arrangement of the internal combustion engine in a separate, closed machine room and at the same time the provision of an at least double-walled line for supplying combustion gas to the internal combustion engine permits, according to the contemporary classification standard, in particular an arrangement of a multiplicity of internal combustion engines in one and the same machine room.

There is preferably provision that the combustion gas pressure adjusting device is arranged outside the machine room in a separate pressure adjusting space. This increases the gas safety of the power generating assembly further because as a result of this separation of the combustion gas pressure adjusting device from the machine room it is also possible, as it were, to implement a double-walled arrangement for the combustion gas pressure adjusting device, by means of the wall of the pressure adjusting space. This therefore is not possible in another way because required valves for the combustion gas pressure adjusting device are not available in a double-walled design.

The inert gas pressure adjusting device is preferably also arranged in the pressure adjusting space. The fact that the line is embodied in at least a double-walled fashion means, in particular, that the line has at least two lines which are arranged interlaced with one another, and consequently an inner line and an outer line which surrounds the inner line. It is possible that the line has more than two lines which are interlaced with one another.

An inner line volume is understood here to be an interior of the inner line of the at least double-walled line, wherein the inner line volume is enclosed by an inner wall, and wherein combustion gas flows in the inner line volume during the operation of the power generating assembly. An outer line volume is understood to be an interior of an outer line of the at least double-walled line, which interior is bounded to the outside by an outer wall and to the inside by the inner wall. The outer line volume accordingly surrounds the inner line volume. During the operation of the power generating assembly inert gas is located in the outer line volume.

An inert gas is understood to be, in particular, a gas which, irrespective of a mixture ratio, does not form an ignitable or combustible, in particular does not form an explosive mixture with the combustion gas. The inert gas is therefore selected, in particular, in such a way that it cannot react with the combustion gas, at any rate under the conditions prevailing during the operation of the power generating assembly. Nitrogen is particularly preferably used as the inert gas, but other inert gases such as, for example, carbon dioxide or noble gases, for example argon, are also possible. Gas mixtures can also be used as inert gas.

A combustion gas is understood to be, in particular, a substance which is gaseous under normal conditions, that is to say, in particular, at 1013 mbar absolute and 25° C., or a gaseous mixture of substances which are suitable as a fuel for operating the internal combustion engine. A methane-containing combustion gas, in particular natural gas, is particularly preferably used.

The combustion gas pressure adjusting device is preferably configured to perform open-loop or closed-loop control of the combustion gas pressure, wherein adjustment of the combustion gas pressure is understood to be, in particular, open-loop or closed-loop control of the combustion gas pressure. The combustion gas pressure adjusting device is particularly preferably embodied as a gas control system and is configured to perform closed-loop control of the combustion gas pressure.

The inert gas pressure adjusting device is preferably configured to perform open-loop or closed-loop control of the inert gas pressure, wherein in this case adjustment of the inert gas pressure is also understood to mean, in particular, open-loop or closed-loop control, particularly preferably closed-loop control.

Preferably a lower pressure setpoint value is predefined for the combustion gas pressure adjusting device than for the inert gas pressure adjusting device, with the result that the inert gas pressure in the outer line volume is higher than the combustion gas pressure in the line volume.

According to one exemplary embodiment of the power generating assembly there is provision that the inert gas supply has a supply vessel which is fluidically connected to the outer line volume via a first switching valve. A supply vessel is understood here to be, in particular, a vessel whose volume is known and is smaller than the volume of the outer line volume. The volume of the supply vessel is preferably smaller than the volume of the outer line volume by a factor of at least 10 to at maximum 40, preferably of at least 20 to at maximum 30, preferably by a factor of 25. It is possible, for example, for the outer line volume to have a volume of 10 L, wherein the volume of the supply vessel is preferably 0.5 L. The supply vessel serves, in particular, as a buffer vessel in order to make available inert gas for maintaining the inert gas pressure in the event of a leakage and, in order to be able to determine a leakage rate easily, in particular on the basis of the known and small volume. The inert gas pressure adjusting device is preferably operatively connected to the first switching valve in order to actuate same. The first switching valve can, in particular, be actuated preferably in a clocked fashion, in particular opened and closed in a clocked fashion with the result that inert gas can be fed to the outer line volume, from the supply vessel, or can be discharged into the supply vessel, via the first switching valve in a clocked fashion. The first switching valve can preferably be switched in a digital fashion into precisely two functional positions, specifically into an open position and into a closed position. In this way, the first switching valve is of simple design and can be actuated in a cost-effective and easy fashion.

According to one development of the invention there is provision that the inert gas supply has an inert gas reservoir, wherein the supply vessel is fluidically connected to the inert gas reservoir via a second switching valve. Alternatively or additionally there is provision that the inert gas supply has an inert gas generating device, wherein the supply vessel is fluidically connected to the inert gas generating device via the second switching valve. The second switching valve is preferably operatively connected to the inert gas pressure adjusting device in order to actuate same, wherein it can, in particular, be actuated, in particular opened and closed, in a clocked fashion. The second switching valve can preferably be switched in a digital fashion into precisely two functional positions, specifically into an open position and a closed position. It can therefore be of simple and cost-effective design and can be actuated easily. An inert gas reservoir is understood here to be, in particular, a reservoir vessel, in particular an inert gas tank, wherein the inert gas tank can preferably be configured as a bottle store. A large quantity of inert gas, which is, in particular, sufficient for a relatively long time at sea, can preferably be stored in the inert gas reservoir. The supply vessel can preferably be supplied in a clocked fashion from the inert gas reservoir by actuating the second switching valve.

The volume of the supply vessel is preferably much smaller than the volume of the inert gas reservoir. Furthermore, it is possible and preferably provided for the volume of the supply vessel to be known more precisely than the volume of the inert gas reservoir.

An inert gas generating device is understood to be a device which is configured to acquire inert gas. This may be, for example, a nitrogen generator which can acquire nitrogen from the ambient air. It is then preferably possible to supply the supply vessel, in particular in a clocked fashion, from the inert gas generating device via the second switching valve.

It is also possible for the inert gas supply to have both an inert gas reservoir and an inert gas generating device, wherein the inert gas reservoir can then preferably be supplied from the inert gas generating device, wherein the supply vessel is preferably supplied from the inert gas reservoir.

The first switching valve and the second switching valve are, when viewed from the outer line volume, preferably connected in series, that is to say arranged fluidically one behind the other. In this context, the first switching valve and the second switching valve are preferably switched in an alternating fashion, in particular opened in an alternating fashion, by the inert gas pressure adjusting device. The supply vessel is therefore, in particular, fluidically connected in an alternating fashion to the outer line volume, on the one hand, and to the inert gas reservoir and/or the inert gas generating device, on the other. In this way, defined quantities of inert gas can, on the one hand, be extracted from the supply vessel and, on the other hand, fed thereto. It is then possible, in particular, in a simple and cost-effective way to calculate a leakage rate by means of the switching cycles or the switching frequency of the switching valves, on the one hand, and the pressure level in the outer line volume, on the other. An additional volume flow-measuring device, which is otherwise necessary for this, can then be dispensed with so that the costs associated with this and the weight associated with this are eliminated. This advantage arises, in particular, from the fact that owing to the small volume of the supply vessel a pressure equilibrium can always be established very quickly with the volume beyond the switching valve, that is to say, in particular, the outer line volume or the inert gas reservoir and/or the inert gas generating device, when a switching valve opens, wherein this pressure is close to a pressure valve which, before the opening of the switching valve, was present in the volume arranged beyond the switching valve, when viewed from the supply vessel. At the same time it arises from this that a multiplicity of opening cycles of the first and second switching valves is always necessary for an increase in pressure and/or a reduction in pressure in the outer line volume because the volume of the supply vessel is not sufficient to adjust the pressure in the outer line volume to a setpoint value after a drop in pressure in said outer line volume by one-off opening of the first switching valve. Instead, there is a need for a cyclical supply to the outer line volume from the supply vessel and for subsequent filling of the supply vessel from the inert gas reservoir and/or the inert gas generating device, or vice versa. In this context, the mass flows and/or volume flows in the individual switching cycles into the supply vessel and from the supply vessel can always be readily calculated on the basis of simple thermodynamic relations, wherein a leakage rate from the outer line volume can be calculated from this, in particular in combination with the switching cycles of the switching valves, in particular with the switching frequency with which the switching valves are actuated, and these volume flows or mass flows.

According to one development of the invention there is provision that the supply vessel is fluidically connected to an inert gas venting line via a third switching valve. The third switching valve is preferably operatively connected to the inert gas pressure adjusting device in order to actuate same, wherein it can, in particular, be actuated in a clocked fashion, in particular opened and closed in a clocked fashion. The third switching valve can preferably be switched in a digital fashion into precisely two functional positions, specifically into an open position and into a closed position. It can therefore be of simple and cost-effective design and can be actuated easily. The supply vessel can be relieved to the inert gas venting line via the third switching valve in a clocked fashion. The third switching valve is, when viewed from the outer line volume, connected, in particular, in series with the first switching valve and in parallel with the second switching valve.

As a result of clocked, in particular alternating, actuation of the first switching valve, of the second switching valve and/or of the third switching valve, it is now possible in a very simple way to perform closed-loop control of the inert gas pressure in the outer line volume in that, in order to increase the pressure, inert gas is fed from the supply vessel to the outer line volume by opening the first switching valve with simultaneously closed second and third switching valves, wherein when the second switching valve is opened and the first and third switching valves are closed inert gas is subsequently fed again to the supply vessel from the inert gas reservoir and/or the inert gas generating device, wherein, in order to lower the pressure, inert gas and pressure can be released from the supply vessel via the inert gas venting line by opening the third switching valve with the first and second switching valves simultaneously closed, wherein when the first switching valve is opened and the second and third switching valves are closed inert gas can subsequently be extracted from the outer line volume and transferred into the supply vessel. Depending on the specifically present pressure level it is also possible firstly to relieve excess pressure from the outer line volume into the supply vessel, and then vent the supply vessel to the inert gas venting line.

An inert gas venting line is understood to be, in particular, a device via which inert gas can be discharged to the surroundings of the power generating assembly. In particular in the case of a marine application of the power generating assembly, the inert gas venting line is preferably integrated into what is referred to as a vent mast, that is to say a venting chimney of a marine vessel.

According to one development of the invention there is provision that a pressure sensor for sensing an inert gas pressure is arranged in or at the outer line volume, wherein the pressure sensor is operatively connected to the inert gas pressure adjusting device. In this way, an actual pressure can always be determined in the outer line volume, with the result that closed-loop control of the inert gas pressure in the outer line volume can be carried out on the basis of an actual/setpoint pressure difference. Furthermore, the pressure level of the inert gas, sensed by means of the pressure sensor, in the outer line volume is preferably used, together with the switching cycles or the switching frequency of the switching valves, to determine a leakage rate.

According to one development of the invention there is provision that the inert gas pressure adjusting device is configured to adjust the inert gas pressure in the outer line volume by cyclically actuating the first switching valve, on the one hand, and the second switching valve or the third switching valve, on the other. As already described above, in this way the pressure in the outer line volume can be increased and/or decreased, in particular closed-loop controlled.

According to one development of the invention there is provision that the inert gas pressure adjusting device is configured to actuate at least two switching valves with a switching frequency which depends on a pressure variable of the inert gas pressure in the outer line volume. The switching frequency can then advantageously be selected as a function of the conditions which are actually present in the outer line volume, wherein, for example in the case of only slow dropping or rising of the pressure a relatively low switching frequency can be selected, wherein in the case of relatively strong or relatively fast dropping or rising of the pressure a relatively high switching frequency can be selected, wherein in this way it is possible to react in a flexible way to a rapid rise in pressure or a leakage in the outer line volume.

A pressure variable is understood to be, in particular, a physical variable setpoint which is associated with the inert gas pressure in the outer line volume or depends thereon. In particular, the inert gas pressure in the outer line volume itself can be used as the pressure variable. It is also possible for a time derivative of the inert gas pressure to be used as a pressure variable. Alternatively or additionally it is also possible for the inert gas pressure to be integrated over a predetermined time period, wherein the integral is used as a pressure variable. It is also possible for a multiplicity of pressure variables, in particular the inert gas pressure itself, a time derivative of the inert gas pressure and/or an integral of the inert gas pressure, to be used to determine the switching frequency. This depends, in particular, on the configuration of the inert gas pressure adjusting device as a pressure controller, specifically, in particular, on whether the inert gas pressure adjusting device is configured as a proportional controller (P controller), as a proportional-differential controller (PD controller), as a proportional-integral-controller (PI controller), as a proportional-integral-differential controller (PID controller) or in some other suitable way. The switching frequency of the switching valves preferably constitutes here a manipulated variable for the closed-loop control of the pressure in the outer line volume.

According to one development of the invention there is provision that the inert gas pressure adjusting device is configured to determine a leakage rate from the outer line volume on the basis of an instantaneous switching frequency of the switching valves, and a pressure variable of the inert gas pressure in the outer line volume. In particular when the instantaneous switching frequency constitutes a manipulated variable for the pressure control and/or is selected as a function of the pressure variable of the inert gas pressure, this is dependent on a pressure loss rate, and consequently a leakage rate from the outer line volume. If the pressure level in the outer line volume is additionally known in the form of the pressure variable, the leakage rate can readily be calculated from the switching frequency, on the one hand, and the pressure variable, on the other, in particular also on the basis of the fact that the volume of the supply vessel is precisely known and is small.

The inert gas pressure adjusting device is preferably configured to generate at least one alarm signal as a function of the determined leakage rate, wherein, in particular, a first threshold value for a first alarm signal is provided. A second relatively high threshold value for a second alarm signal is preferably also provided, wherein the alarm signals are output if the threshold values assigned to them for the leakage rate are exceeded.

An alarm signal is understood here to be a message to an operator of the power generating assembly, wherein the alarm signal can be, in particular, a visual signal, an acoustic signal, a vibration signal, an electrical signal or some other suitable signal. Various alarm signals which correspond to leakage rates of various magnitudes can be associated, for example, with various colors or with various alarm signal intensities. For example it is possible that when a first threshold value for the leakage rate is exceeded, a yellow light lights up in order to indicate that a leakage has occurred which is still tolerable and does not require any immediate measures. When the second, relatively high threshold value for the leakage rate is exceeded, preferably a red light is activated which indicates that there is a leak in the outer line volume which can at present still be tolerated but requires measures to eliminate it and, in particular, as a precaution against further increase in the leakage.

There is preferably provision that the inert gas pressure adjusting device is configured to stop the internal combustion engine if a third threshold value for the leakage rate which represents a leakage which is no longer tolerable is exceeded, wherein, in particular, a risk of fire or explosion may be present. This third threshold value is preferably higher than the second threshold value and/or higher than the first threshold value. Preferably, at the same time a third alarm signal is generated which, on the one hand, signals the leakage to the operator of the power generating assembly and, on the other hand, signals the stopping of the internal combustion engine to said operator.

The internal combustion engine is preferably embodied as a reciprocating piston engine. It is possible for the internal combustion engine to be configured to drive a passenger car, a truck or a utility vehicle. In one preferred exemplary embodiment, the internal combustion engine serves to drive, in particular, relatively heavy land vehicles or watercraft, for example mining vehicles, trains, wherein the internal combustion engine is used in a locomotive or a power car, or ships. The use of the internal combustion engine to drive a vehicle which is used for defense, for example a tank, is also possible. An exemplary embodiment of the internal combustion engine is preferably also used in a stationary fashion, for example for the stationary energy supply in an emergency power supply mode, continuous load mode or peak load mode, wherein the internal combustion engine preferably drives a generator in this case. A stationary application of the internal combustion engine to drive auxiliary assemblies, for example fire extinguishing pumps on drilling rigs, is also possible. Furthermore, an application of the internal combustion engine in the field of the extraction of fossil raw materials and, in particular, fuels, for example oil and/or gas is possible. The use of the internal combustion engine in the industrial field or in the field of construction, for example in a construction or building machine, for example in a crane or an excavator, is also possible. The internal combustion engine is preferably embodied as a diesel engine, as a gasoline engine, as a gas engine for operation with natural gas, biogas, special gas or some other suitable gas. In particular, if the internal combustion engine is embodied as a gas engine, it is suitable for use in a cogeneration plant for the stationary generation of energy.

It is possible for the internal combustion engine to have a multiplicity of cylinder banks, for example an A bank and a B bank. In this case, each cylinder bank is preferably assigned a dedicated, at least double-walled line, wherein each cylinder bank is also assigned a dedicated, separate outer line volume. Each of these line volumes is preferably fluidically connected to the supply vessel via a separate first switching valve. Moreover, the same as has already been generally stated for an outer line volume and a first switching valve applies to any outer line volume of a cylinder bank and to any first switching valve. The supply vessel, the second switching valve and preferably the third switching valve are preferably common to all cylinder banks and consequently in each case are provided only once.

The object is also achieved in that a vehicle is provided which has a power generating assembly as claimed in one of the exemplary embodiments described above. The vehicle is particularly preferably embodied as a marine vessel. A particularly preferred exemplary embodiment of the vehicle is embodied as a harbor tug. The power generating assembly proposed here permits classification requirements for the safe operation of internal combustion engines with combustion gas onboard a marine vessel to be satisfied in a particularly favorable way.

The vehicle preferably has a machine room in which at least one internal combustion engine of the power generating assembly is arranged. The combustion gas pressure adjusting device and the inert gas pressure adjusting device are preferably arranged in a separate pressure adjusting space which is divided by the machine room. The line of the combustion gas supply is preferably embodied at least in a double-walled fashion only in the machine room. The pressure adjusting space is preferably divided off from a storage space in which a combustion gas reservoir is arranged. An inert gas reservoir and/or an inert gas generating device can be arranged in the same storage space or in another storage space.

The supply vessel is preferably arranged in the pressure adjusting space.

The object is also achieved in that a method for adjusting an inert gas pressure in an outer line volume of an at least partially double-walled combustion gas supply is provided, wherein the inert gas pressure is selected to be higher in an outer line volume than a combustion gas pressure in an inner line volume of the combustion gas supply. In this way, in particular the advantages which have already been described in conjunction with the power generating assembly are obtained.

The inert gas pressure and/or the combustion gas pressure are particularly preferably closed-loop controlled, wherein a setpoint value for the inert gas pressure is preferably higher than a setpoint value for the combustion gas pressure.

Within the scope of the method, the inert gas pressure in the outer line volume is preferably adjusted by cyclically actuating a first switching valve, which is arranged in a first fluid connection between the outer line volume and a supply vessel, on the one hand, and a second switching valve, which is arranged in a second fluid connection between the supply vessel and an inert gas reservoir and/or an inert gas generating device, and/or a third switching valve which is arranged in a third fluid connection between the supply vessel and an inert gas venting line, on the other.

At least two switching valves, selected from the first switching valve, the valve second switching valve and the third switching valve, are preferably actuated with a switching frequency which is selected as a function of a pressure variable of the inert gas pressure in the outer line volume.

A leakage rate of inert gas from the outer line volume is preferably determined on the basis of an instantaneous switching frequency and an instantaneous pressure variable of the inert gas pressure in the outer line volume.

The description of the power generating assembly and of the vehicle, on the one hand, and of the method, on the other, are to be understood as complementary to one another. Features of the power generating assembly and of the vehicle which have been explained explicitly or implicitly in conjunction with the method are preferably, individually or when combined with one another, features of a preferred exemplary embodiment of the power generating assembly or of the vehicle. Method steps which have been explained explicitly or implicitly in conjunction with the power generating assembly and/or the vehicle are preferably, individually or when combined with one another, steps of a preferred embodiment of the method. Said method is preferably distinguished by at least one method step which is conditioned by at least one feature of an inventive or preferred exemplary embodiment of the power generating assembly or of the vehicle. The power generating assembly and/or the vehicle are/is preferably distinguished by at least one feature which is conditioned by at least one step of an inventive or preferred embodiment of the method.

The invention will be explained in more detail below with reference to the drawing, in which:

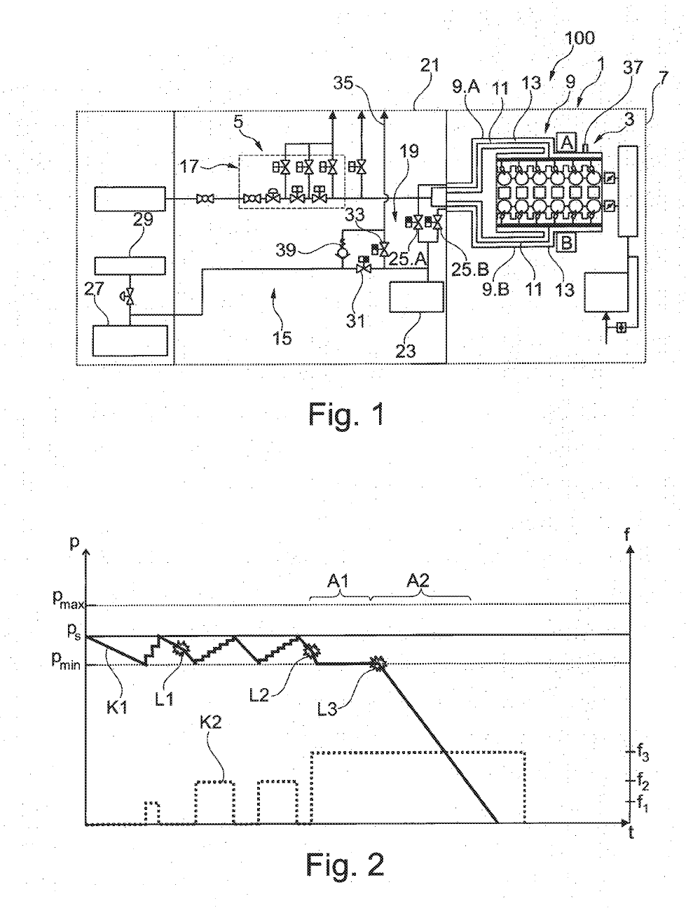

FIG. 1 shows a schematic illustration of an exemplary embodiment of a power generating assembly, and

FIG. 2 shows a schematic illustration of the method of functioning of the power generating assembly.

FIG. 1 shows a schematic illustration of an exemplary embodiment of a vehicle 100 with a power generating assembly 1 which has an internal combustion engine 3 and a combustion gas supply 5 which is connected to the internal combustion engine 3 in order to supply combustion gas. The combustion gas supply 5 is embodied in a double-walled fashion at least in the region of the internal combustion engine 3, here in particular within a machine room 7, that is to say has a double-walled line 9, wherein the internal combustion engine 3 has two cylinder banks A, B here, wherein each cylinder bank is assigned a separate double-walled line 9.A, 9.B.

The double-walled lines 9 each have an inner line volume 11 in which combustion gas flows during the operation of the internal combustion engine 3, and an outer line volume 13 which surrounds the inner line volume 11 and in which an inert gas is arranged in any case during the operation of the internal combustion engine 3.

The outer line volume 11 is fluidically connected to an inert gas supply 15.

A combustion gas pressure adjusting device 17 is provided which is configured to adjust the combustion gas pressure in the inner line volume 11, wherein the combustion gas pressure adjusting device is embodied here, in particular, as a gas control system and is configured to perform closed-loop control of the combustion gas pressure in the inner line volume 11.

An inert gas pressure adjusting device 19 is provided which is configured to adjust an inert gas pressure, in particular to perform closed-loop control thereof, in the outer line volume 13.

The combustion gas pressure adjusting device 17 and the inert gas pressure adjusting device 19 are arranged here in a separate pressure adjusting space 21 which is separated off from the machine room.

The combustion gas pressure adjusting device 17 and the inert gas pressure adjusting device 19 are configured to select the inert gas pressure and the combustion gas pressure in such a way that the inert gas pressure in the outer line volume 13 is higher than the combustion gas pressure in the inner line volume 11.

The inert gas supply 19 has a supply vessel 23 which is fluidically connected to the outer line volume 13 via a first switching valve 25. In this context, the cylinder banks A, B are each assigned a first switching valve 25.A, 25.B, wherein in the text which follows only the method of functioning of a first switching valve 25 is described in conjunction with a cylinder bank A, B, wherein the method of functioning for the other cylinder bank B, A is completely analogous. It is possible that the internal combustion engine 3 has only one cylinder bank, wherein only one outer volume 13 and only one first switching valve 25 are then also provided. However, the concept can be extended to any desired number of cylinder banks A, B by assigning each cylinder bank a separate outer volume 13, and wherein a dedicated first switching valve 25 is assigned to each separate outer line volume 13.

Everything which is stated generally below about a first switching valve 25 then applies here specifically to both first switching valves 25.A, 25.B.

The inert gas supply 25 also has an inert gas reservoir 27 and here additionally also an inert gas generating device 29. Inert gas can be generated by means of the inert gas generating device 29, which is preferably embodied as a nitrogen generator, and said inert gas can then be stored in the inert gas reservoir 27. The supply vessel 23 is fluidically connected here, in particular, to the inert gas reservoir 27 via a second switching valve 31. Viewed from the outer line volume 13, the first switching valve 25 and the second switching valve 31 are arranged in series. The supply vessel 23 is fluidically arranged here between the second switching valve 31 and the first switching valve 25.

The supply vessel 23 is fluidically connected to an inert gas venting line 35 via a third switching valve 33. The inert gas venting line 35 can be integrated, for example, in a vent mast of a marine vessel which has the power generating assembly 1.

Viewed from the outer line volume 13 again, the third switching valve 33 is arranged in series with the first switching valve 25 and in parallel with the second switching valve 31.

A pressure sensor 37 is provided which is configured and arranged so as to sense the inert gas pressure in the outer line volume 13. The pressure sensor is preferably operatively connected to the inert gas pressure adjusting device 19. The latter preferably has a control unit (not illustrated here) which is operatively connected to the switching valves 31, 33, 35 and to the pressure sensor 37.

Each cylinder bank A, B is preferably assigned a dedicated pressure sensor, wherein for the sake of simpler illustration only one pressure sensor 37, which is assigned to the cylinder bank A, is illustrated here.

FIG. 1 also illustrates a non-return valve 39 which is embodied as an overpressure safety valve and which is configured to vent the inert gas reservoir 27 to the inert gas venting line 35 when there is an unacceptable rise in pressure upstream of the second switching valve 31.

FIG. 2 shows a schematic illustration of the method of functioning of the power generating assembly 1 and, in particular, of the inert gas pressure adjusting device 19. In this context, the time t is plotted on the horizontal axis and pressure p in the outer line volume 13 is plotted on a first, left-hand vertical axis, said pressure p being preferably sensed by means of the pressure sensor 37, wherein a switching frequency f for the switching valves 25, 31, 33 is plotted on a second, right-hand vertical axis. In this context, in the text which follows only an actuation of the first switching valve 25 and an actuation of the second switching valve 31 are described because the illustration which is provided in this respect is limited to the behavior of the inert gas pressure adjusting device in the case of a leakage, consequently a drop in pressure. However, it is readily comprehensible that when there is an unacceptable rise in pressure the first switching valve 25 and the third switching valve 33 could be actuated in an analogous fashion in order to relieve the pressure of the outer line volume 13 to the inert gas venting line 35 via the supply vessel 23. Such an unacceptable rise in pressure can occur, for example, for thermal reasons, in particular in the case of a rise in temperature in the machine room 7.

A setpoint pressure pₛ and a pressure band between a minimum pressure pₘᵢₙ and a maximum pressure pₘₐₓ are indicated in the diagram in FIG. 2, in said pressure band the pressure in the outer line volume 13 can differ from the setpoint pressure pₛ, wherein such a pressure difference is tolerated without a further measure of the inert gas pressure adjusting device 19.

A first curve K1, which is illustrated here in a continuous form, shows the profile of the actual pressure in the outer line volume 13 with the time t, and a second curve K2, which is illustrated here in a dashed form, shows a switching frequency for the switching valves 25, 31 as a function of the time t.

If the pressure profile of the first curve K1 starting from the left-hand vertical axis of the diagram is considered, it becomes apparent that the actual pressure drops starting from the setpoint pressure pₛ with the time t with a certain rate, for example because a certain leakage, in particular an unavoidable residual leakage, is already present. If the actual pressure reaches the minimum pressure pₘᵢₙ, the second switching valve 31 and the first switching valve 25 are actuated alternately with a first switching frequency f₁, as a result of which the pressure in the outer line volume 13 is increased incrementally. If the second switching valve 31 is closed and the first switching valve 25 is opened, inert gas flows from the supply vessel 23 into the outer line volume 13 if the pressure in the supply vessel 23 is higher than the pressure in the outer line volume 13. This is typically the case when there is a leakage in the outer line volume 13, wherein, in particular, the pressure in the inert gas reservoir 27 or in the inert gas generating device 29 is preferably higher than the setpoint pressure pₛ. This then applies correspondingly also to the pressure in the supply vessel 23 after it has been filled from the inert gas reservoir 27. If the first switching valve 25 is closed and the second switching valve 31 is opened, inert gas flows from the inert gas reservoir 27 into the supply vessel 23. This occurs, as already stated, in an alternating fashion, wherein the pressure in the outer line volume 13 is increased incrementally.

If the pressure reaches the pressure setpoint value pₛ again, the actuation of the switching valves 25, 31 is ended. The actual pressure then drops with the rate already described above, which rate can correspond, in particular, to an unavoidable residual leakage rate.

At a specific time, which is characterized here by a first leakage event L1, an increase in the leakage occurs, or a leakage which is not provided occurs for the first time beyond the unavoidable residual leakage. It is therefore possible that a leakage which occurs for the first time or that a leakage which is already present becomes larger. As a result, the leakage rate becomes larger, and the actual pressure drops more quickly than before to the minimum pressure pₘᵢₙ. Subsequently, the switching valves 25, 31 are actuated with a second, relatively high switching frequency f2, and the pressure is in turn increased incrementally, this time with a relatively short sequence owing to the relatively short switching frequency, until said pressure reaches the setpoint pressure pₛ again. Subsequently, the actuation of the switching valves 25, 31 stops.

The pressure then drops with the second, relatively large leakage rate until its pressure reaches the minimum pressure pₘᵢₙ again, wherein the switching valves are then again actuated with the second switching frequency f2 until the pressure reaches the setpoint pressure pₛ.

At a second time, characterized by a second leakage event L2, a critical increase in the leakage occurs, with the result that the leakage rate increases once more and the pressure drops more quickly to the minimum pressure pₘᵢₙ. The switching valves 25, 31 are then actuated with a third, maximum switching frequency f₃, wherein the profile of the first curve K1 shows that with this maximum switching frequency and the present leakage rate it is just still possible to keep the inert gas pressure in the outer line volume 13 to the minimum pressure level pₘᵢₙ.

The switching frequency for the switching valves 25, 31 is preferably selected as a function of a pressure variable, in particular the actual pressure, a derivative of the actual pressure over time and/or integration of the actual pressure over a specific time period. A leakage rate is preferably calculated as a function of the switching frequency and the pressure variable. In this context it is monitored whether the leakage rate exceeds a first threshold value. In the present example, this is not the case until after the second leakage event L2. The preceding leakage is accordingly tolerated. However, after the second leakage event L2 the leakage rate exceeds the predetermined, first threshold value, with the result that a first alarm signal A1 is output.

At a third leakage event L3, the leakage rate increases once more, with the result that despite continued actuation of the switching valves 25, 31 with the maximum switching frequency f₃ it is no longer possible to maintain the pressure in the outer line volume 13. The latter therefore drops further. The leakage rate preferably exceeds a second threshold value here, with the result that a second alarm A2 is output.

A third threshold value for the leakage rate is also preferably provided, wherein the internal combustion engine 3 is switched off if the leakage rate exceeds this third threshold value.

In addition, it is also explained that an excess pressure which occurs in the outer line volume 13, for example for thermal reasons, in particular when the maximum pressure pₘₐₓ is reached, can be reduced incrementally by alternately actuating the third switching valve 33 and the first switching valve 25, wherein the procedure is selected here in a way which is precisely analogous to the procedure for increasing the pressure in the outer line volume 13.

Overall it becomes apparent that the power generating assembly 1, the vehicle and the method permit very safe operation of internal combustion engines with combustion gas, in particular for marine applications. In this context, there is no need for any additional measuring devices, in particular no volume flow measuring device, in order to detect a leakage rate. Double shutting off with respect to separation of the combustion gas from the inert gas takes place. Furthermore, the power generating assembly and, in particular, the inert gas pressure adjusting device have a simple design, wherein, in particular, there is no need for pressure control by means of a pressure control valve.

1-10. (canceled)

11. A power generating assembly, comprising:
an internal combustion engine;
an inert gas supply;
a combustion gas supply connected to the internal combustion engine to supply combustion gas, wherein the combustion gas supply includes, at least in a region of the internal combustion engine, an at least double-walled line that has an inner line volume for combustion gas, and an outer line volume, wherein the outer line volume is fluidically connected to the inert gas supply;
a combustion gas pressure adjusting device configured to adjust a combustion gas pressure in the inner line volume; and
an inert gas pressure adjusting device configured to adjust an inert gas pressure in the outer line volume, wherein
the combustion gas pressure adjusting device and the inert gas pressure adjusting device are configured to select the inert gas pressure and the combustion gas pressure so that the inert gas pressure is higher than the combustion gas pressure.

12. The power generating assembly according to claim 10, wherein the inert gas supply includes a supply vessel fluidically connected to the outer line volume via a first switching valve.

13. The power generating assembly according to claim 12, wherein the inert gas supply includes an inert gas reservoir and/or an inert gas generating device, and a second switching valve that fluidically connects the supply vessel to the inert gas reservoir and/or to the inert gas generating device.

14. The power generating assembly according to claim 13, wherein the inert gas supply includes an inert gas venting line and a third switching valve that fluidically connects the supply vessel to the inert gas venting line.

15. The power generating assembly according to claim 11, further comprising a pressure sensor for sensing the inert gas pressure in the outer line volume and operatively connected to the inert gas pressure adjusting device.

16. The power generating assembly according to claim 14, wherein the inert gas pressure adjusting device is configured to adjust the inert gas pressure in the outer line volume by cyclically actuating the first switching valve, on the one hand, and the second switching valve or the third switching valve, on the other.

17. The power generating assembly according to claim 14, wherein the inert gas pressure adjusting device is configured to actuate at least two of the switching valves with a switching frequency as a function of a pressure variable of the inert gas pressure in the outer line volume.

18. The power generating assembly according to claim 11, wherein the inert gas pressure adjusting device is configured to determine a leakage rate from the outer line volume based on an instantaneous switching frequency and a pressure variable of the inert gas pressure in the outer line volume.

19. A vehicle comprising a power generating assembly according to claim 11.

20. A method for adjusting an inert gas pressure in an outer line volume of an at least partially double-walled combustion gas supply, comprising the step of selecting the inert gas pressure to be higher in an outer line volume of the combustion gas supply than a combustion gas pressure in an inner line volume of the combustion gas supply.
